(19) United States
(12) Patent Application Publication
(10) Pub. No.: US 2014/0250361 A1
(43) Pub. Date: Sep. 4, 2014

(54) Preserving document construct fidelity in converting graphic-represented documents into text-readable documents

(71) Applicants: Mark Wineman, San Diego, CA (US); Yizhen Jiang, Shanghai (CN); Dazheng Wang, Shanghai (CN)

(72) Inventors: Mark Wineman, San Diego, CA (US); Yizhen Jiang, Shanghai (CN); Dazheng Wang, Shanghai (CN)

(73) Assignee: Macromedia, Inc., San Francisco, CA (US)

(21) Appl. No.: 10/955,972

(22) Filed: Sep. 30, 2004

(51) Int. Cl. G06F 17/21; G06F 17/22

(52) U.S. Cl. CPC G06F 17/211; G06F 17/2247
USPC 715/234; 715/249

(57) ABSTRACT

A system and method are disclosed for defining a document construct in a text-readable document converted from a graphic-represented document. In operation, the graphic-represented document is rendered in memory of a computer operating the system and method. A plurality of horizontal and vertical lines are established across the whitespace in the graphic-represented document, such that the lines do not touch any graphics on the graphic-represented document. Regions within the document that are defined by the intersections of the horizontal and vertical lines are then analyzed for patterns or other indicia of a document construct. When such a construct is determined, construct indicators are inserted within the data describing the graphic-represented document as it is converted into the text-readable document.

### TECHNICAL FIELD

The present invention relates, in general, to electronic documents and, more specifically, to the preservation of document constructs in text-readable documents converted from graphic-represented documents.

### BACKGROUND OF THE INVENTION

Computers and electronics have infiltrated most aspects of life in the modern world. Word processors, scanners, and faxes have led to a proliferation of electronic documents that may be shared with multiple different persons in various different locations. Some electronic documents may be in a text-readable format, such as Hypertext Markup Language (HTML), MICROSOFT CORPORATION's WORD™ DOC format, Real Text Format (RTF), plain text (TXT) format, or the like. These documents are text-readable, such that word searches or text insertions, modification, and/or deletions, may be made directly in the document. Other electronic documents may be in a graphic-represented format, such as ADOBE SYSTEMS INCORPORATED's Portable Document Format (PDF), MACROMEDIA INC's FLASHPAPER™, Tagged Image File Format (TIFF), and the like. Graphic-represented documents may also present text and graphics when displayed. However, the displayed content is represented by text, graphics, patterns, glyphs, or the like, which may be printed and displayed on the monitor. Humans may recognize the text as a particular construct, such as a table or list, the rendering system does not identify such blocks as particular constructs.

Graphic-represented documents have increased in popularity as their mechanisms and formats have become more advanced and more platform neutral. For example, PDF files have become a de facto standard in electronic document publishing. Many electronic documents are now made available on the Internet or other data networks in PDF format because it allows the document to be displayed consistently across many different platforms running a PDF reader and also allows that document to be printed out with the same or similar fidelity of the original document. Moreover, computer-based faxes are typically rendered in TIFF format to be transferred to and from faxing parties, again, because of the consistency and fidelity of the display of the faxed documents on various electronic platforms and the subsequent printing onto hard media. Additionally, FLASHPAPER™ documents may be displayed consistently in MACROMEDIA INC.'s MACROMEDIA FLASH™ player available on most computer platforms.

With the increase in these graphic-represented documents, it sometimes becomes important to be able to convert the graphic-represented document into a text-readable document. For example, a party who receives an electronic fax in TIFF format may desire to convert the TIFF file into an actual text-readable document that he or she may edit in a word processing application. Similarly, if a company is designing an interactive Internet application, such as an on-line help application, it may be desirable to convert electronic support documents, that are in a format such as PDF, into HTML, in order to easily build the Internet application. Such conversions from graphic-represented documents into text-readable documents are typically performed by some kind of Optical Character Recognition (OCR) application. Some PDF documents may include the text in addition to the graphics. However, PDF documents that are created using a scanner typically result in a purely graphical document which would use an OCR function to obtain the underlying represented text.

In OCR, certain algorithms and heuristics may be employed to analyze the graphic illustrating the text character and then make an educated guess at what character is represented. The resulting group of characters are typically saved in a text-readable format. While this process converts the graphic to text, it generally does not interpret the different document constructs of the graphic-represented document. Document constructs may be such elements or styles as tables, lists, columns, and the like. Within the text-readable document, such document constructs are defined with additional style coding within the text-readable document. Therefore, the difference between text that is simply arranged in a paragraph will be-coded or tagged differently from text that is formatted into a document construct, such as a list, table, column, or the like.

Additional conversion applications exist that convert graphic-represented documents to text-readable documents. Some such conversion applications allow a user to physically mark the graphic-represented document to indicate blocks of graphics that represent a particular type of document construct. In order to mark the graphic-represented document, the user would typically draw a bounding box around the specific set of graphics that were the specific document construct and then enter which type of document construct applied to the bounded area. Other specific processes may exist for the user to mark the graphic-represented document, but each such process requires the user to manually inspect the entire document. When the conversion application begins the conversion process, it applies the document construct mark entered by the user to format the converted text according to the particular formatting style or element marked by the user.

While this method provides an accurate way to preserve document constructs in the conversion of a graphic-represented document to a text-readable document, it takes considerable time from a user to go through the entire graphic-represented document to manually mark each separate document construct. Moreover, this method is static, such that any subsequent changes to the document may or may not cause the content to move outside of the annotation, causing a need for the author to re-annotate the entire document.

### BRIEF SUMMARY OF THE INVENTION

The present invention is directed to a system and method for automatically analyzing a graphic-represented document to determine various document constructs to preserve in a conversion to a text-readable document that may be freely edited as if the construct was originally native to the resulting application. During the conversion process, the graphic-represented document is rendered in memory as it would be rendered on the visual display or printed. The system establishes a series of horizontal lines either virtually or physically across the document only within the whitespace of the document. Document whitespace is the area of the document that is not covered by graphic-represented text or other graphics. After the document is covered with these horizontal lines, vertical lines are then established either virtually or physically within the document whitespace. As with the horizontal lines, the vertical lines are established, where possible, across the entire document.

When the horizontal and vertical lines have all been applied to the graphic-represented represented document, the system analyzes the sections of the document defined by the line intersections. These areas are examined for any indicia of particular document constructs. The process of establishing the horizontal and vertical lines is continued within each of these sections until the resulting sub-sections are small enough that the conversion application may determine that they are no longer of interest with regard to detecting document constructs.

For example, if the vertical lines traverse the entire length of the document within the available canvas area of the document, this may be an indicia of columns. If the area defined by the intersections result in a series of similarly sized boxes across some area of the available canvas area, this may be an indicia of a table. Moreover, if the area defined by the intersections results in a first column of boxes that are relatively small, and contain bullet glyphs or numbers which are adjacent to a series of other larger boxes in an adjacent column, this may be an indicia of a bulleted or numbered list. Depending on the particular indicia recognized by the system, data that indicates such a particular document construct will be placed with the graphic-represented document. When the graphic-represented document is converted into the text-readable document, the conversion system uses the document construct notation to create the text-readable portion of the document according to the particular document construct. Thus, a column notation will result in the text-readable document being coded for columns. Similarly, a table or list notation will result in the text being tagged or coded as a table or list, respectively. Therefore, the document constructs are preserved in the text-readable document converted from the graphic-represented document without requiring manual notation by the user. These preserved constructs are actually constructed in a manner consistent with the native creation of a similar construct in the format of the host application for the text-readable document. For example, a table converted into a WORD™ document will be a WORD™ table. Similarly, a list converted into an HTML document will be created as an HTML list.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is an illustration of an electronic document in a graphic-represented document format;

FIG. 2 is a block diagram illustrating a computer system operating a conversion application configured according to an embodiment of the present invention;

FIG. 3A is an illustration of an electronic document as rendered in memory by a conversion application configured according to another embodiment of the present invention;

FIG. 3B is an illustration of an electronic document, as rendered in memory by a conversion application configured according to another embodiment of the present invention, showing vertical lines and drawn within the first pass of the conversion application;

FIG. 3C is an illustration of an electronic document, as rendered in memory by a conversion application configured according to another embodiment of the present invention, showing additional vertical lines drawn during the second pass of the conversion application;

FIG. 3D is an illustration of an electronic document, as rendered in memory by a conversion application configured according to another embodiment of the present invention, showing additional vertical lines drawn within the third pass of the conversion application;

FIG. 4 is an illustration of an electronic document as rendered in memory by a conversion application configured according to another embodiment of the present invention;

FIG. 5 is an illustration of an electronic document as rendered in memory by a conversion application configured according to another embodiment of the present invention;

FIG. 6 is a flowchart illustrating example steps taken to implement one embodiment of the present invention;

FIG. 7 is a flowchart illustrating example steps performed in implementing another embodiment of the present invention; and

FIG. 8 illustrates a computer system adapted to use embodiments of the present invention.

### DETAILED DESCRIPTION OF THE INVENTION

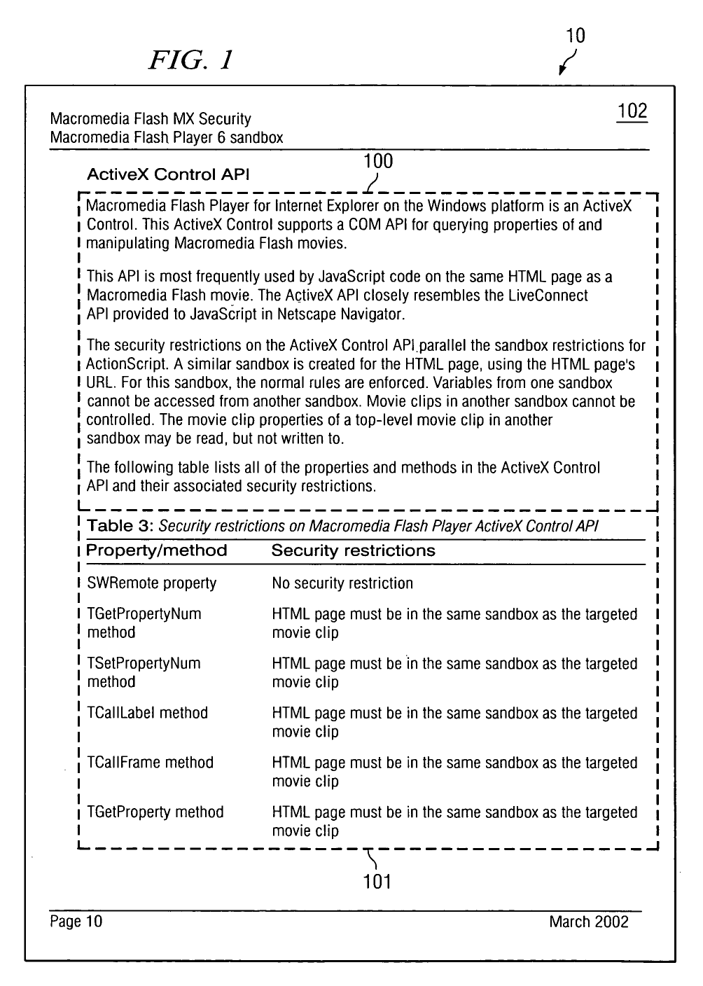

FIG. 1 is an illustration of electronic document 10 in a graphic-represented document format. Electronic document 10 may be any number of different formats for graphic-represented documents, such as PDF, TIFF, FLASHPAPER™, and the like. Electronic document 10 includes graphics, images, and/or glyphs painted within the available content area of the document. Electronic document 10 includes graphic representations of two different document constructs. The graphics shown in box 100 represents simple text arranged in normal paragraph styles. The graphics shown in box 101, however, represents text arranged in a table format. In addition to the document constructs on electronic document 10, whitespace 102, the document space with no graphics or marks placed thereon, is dispersed around the various graphics.

It should be noted that in various embodiments of the present invention, when purely graphical formatted documents are used, an OCR function could be applied in order to obtain the actual text of the underlying document.

A text-readable document, such as HTML, DOC format, RTF format, and the like, includes additional tagging or coding that identifies any particular block of text, such as the text in box 101, as a table. The displaying application, such as a Web browser for HTML documents, or a word processor for DOC and/or RTF format documents, uses that coding to arrange the text into the related special construct, such as a table. Thus, when a conversion tool configured according to one embodiment of the present invention is used to convert electronic document 10 into a text-readable document additional descriptive data is automatically added to the document information stream describing electronic document 10 in order to signal the conversion application that block 102 contains a table.

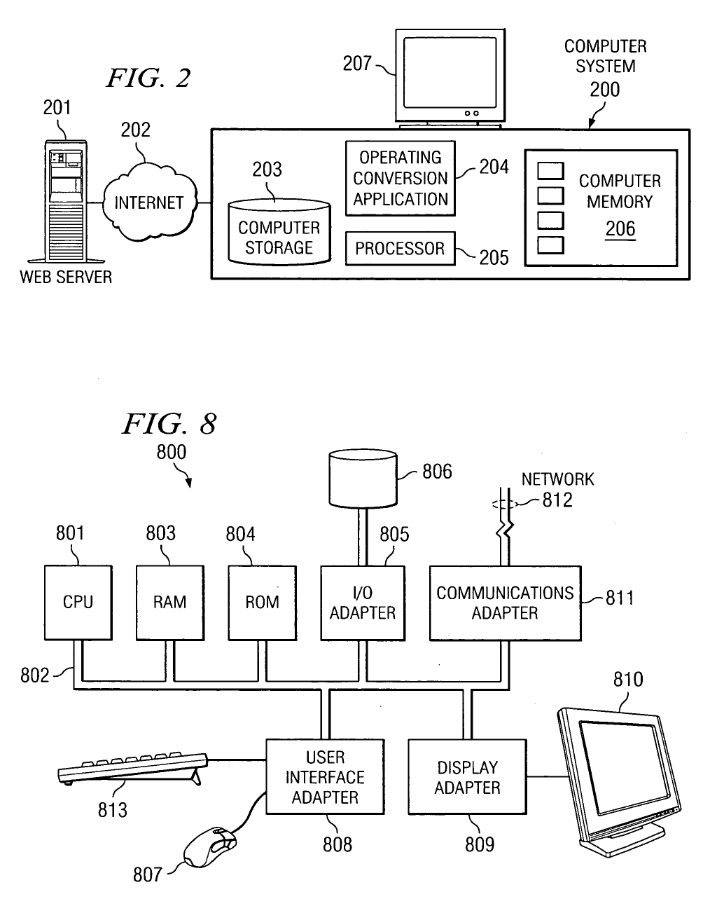

FIG. 2 is a block diagram illustrating computer system 200 operating conversion application 204 configured according to an embodiment of the present invention. In operation, a user at computer system 200 may obtain an electronic document from various means. For example, computer system 200 may access Web server 201 over Internet 202 in order to download a PDF document. The PDF document may be stored on computer storage 203, which may be a hard disk, CD ROM, DVD-ROM, flash memory, or the like. In this example, the user desires to convert the PDF document into an HTML document. Conversion application 204 is initiated and run by processor 205. The embodiment of the present invention depicted in FIG. 2 begins by rendering the PDF document in computer memory 206. Computer memory 206 may be some type of writeable access memory, such as random access memory (RAM).

Conversion application 204 establishes varying width horizontal lines within the whitespace of the PDF document rendered in computer memory 206. Vertical lines are then established within the whitespace. The horizontal and vertical lines only cover or correspond to the whitespace and do not cross into the text, graphics, or glyphs. Once the lines are established, conversion application 204 analyzes the portions of PDF document within the intersection of the horizontal and vertical lines. Depending on the pattern or shape of the rectangles defined by the intersecting lines, conversion application 204 determines what type of document constructs, if any, are displayed on the PDF document and places descriptive data indicating which document construct is present. Through converting the PDF document into text, conversion application 204 creates a document information stream that will be used to generate the resulting HTML document. A document information stream is a stream of data and instructions that may typically be used when sending a particular document to a printer, or for rendering on the screen. The information stream instructs how to actually render, display, or create the image of the document.

When used in conjunction with the various embodiments of the present invention, document construct data is added to the document information stream to identify which portions of the PDF document are a paragraph, table, list, column, a paragraph, a graphical annotation, an annotated graphic (which is a graphic containing annotations, as opposed to a graphical annotation), an article, or the like. Thus, when generating the HTML document, document construct tabs are placed around the text corresponding to the document construct that was graphically rendered in the PDF document. The HTML document may then be displayed on computer display 207 which will show the corresponding document construct tags.

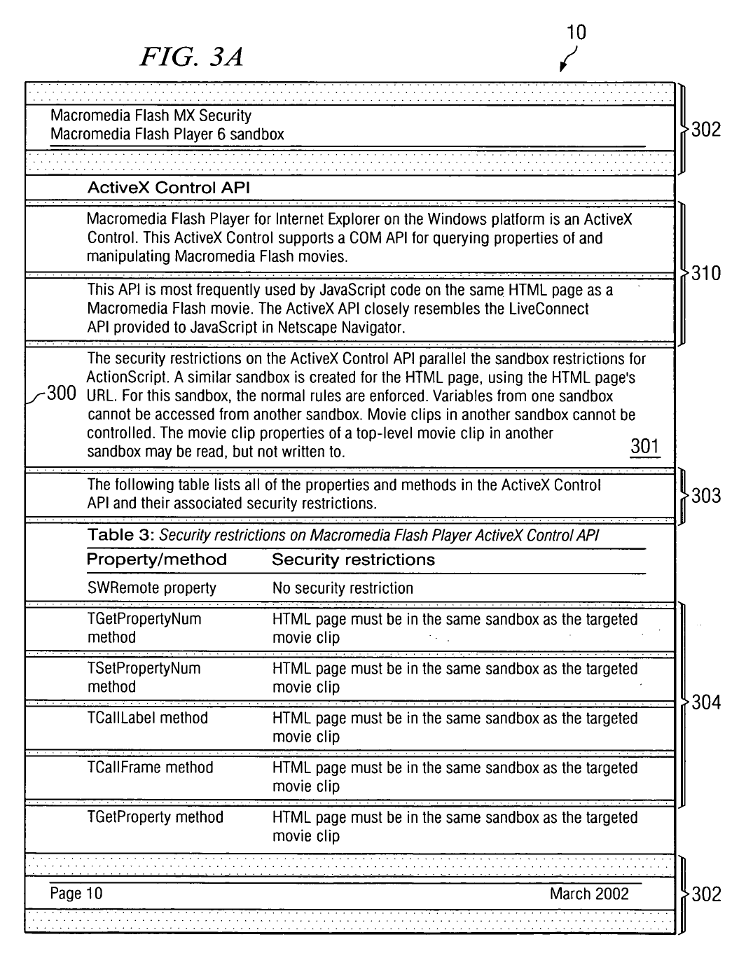

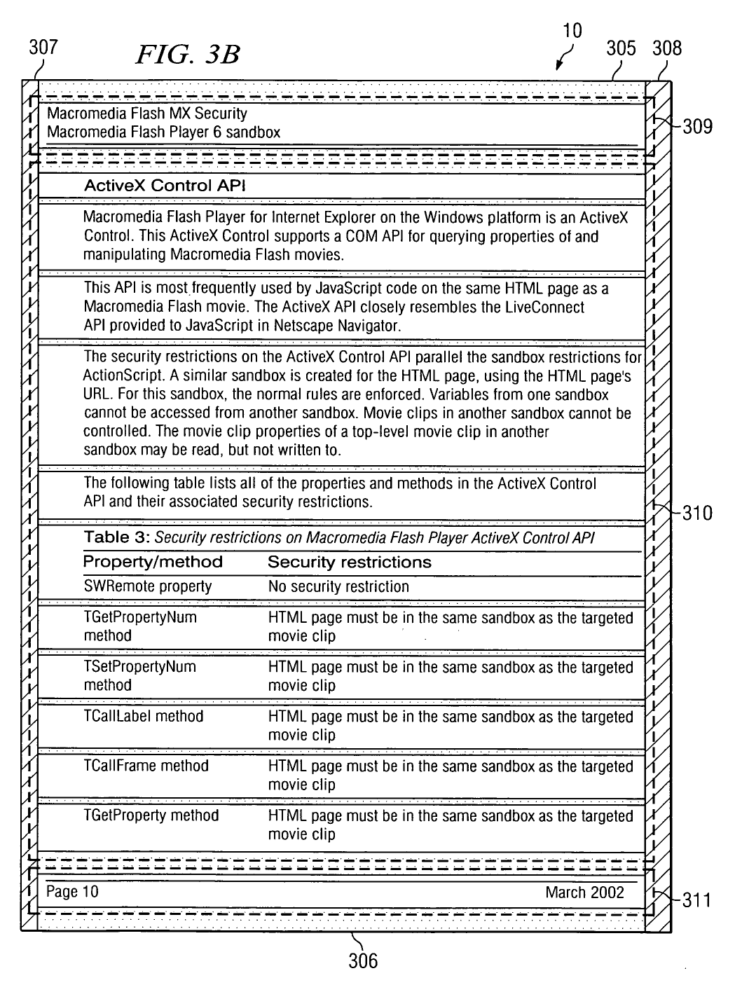

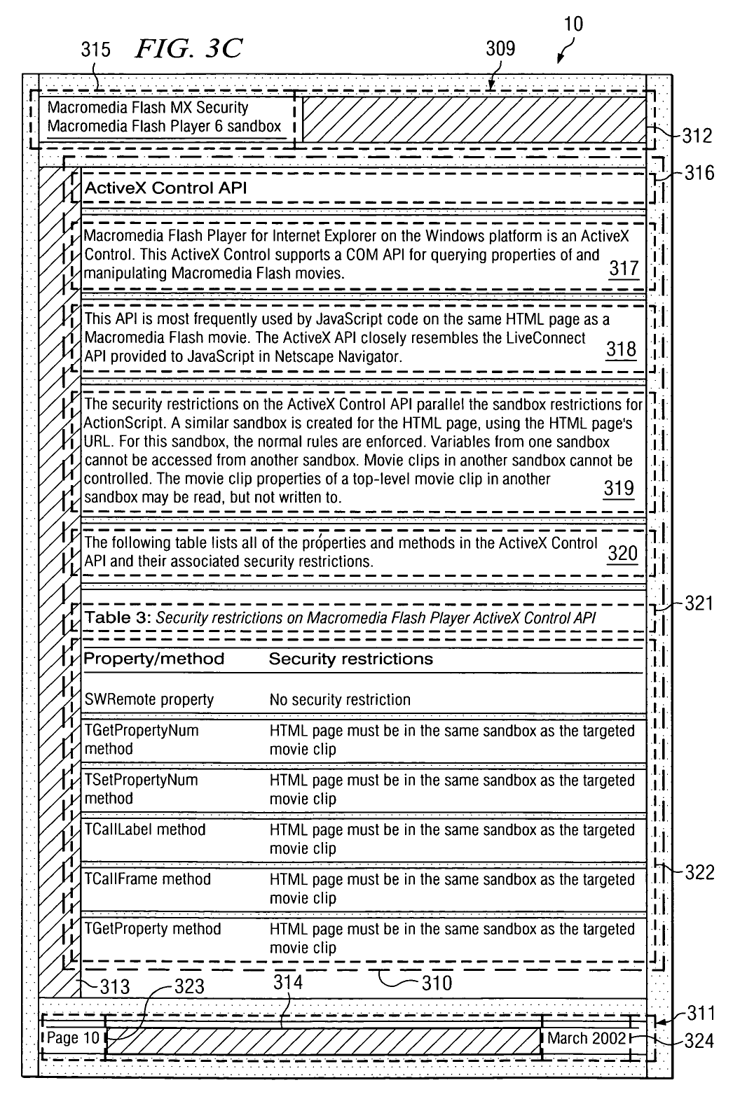

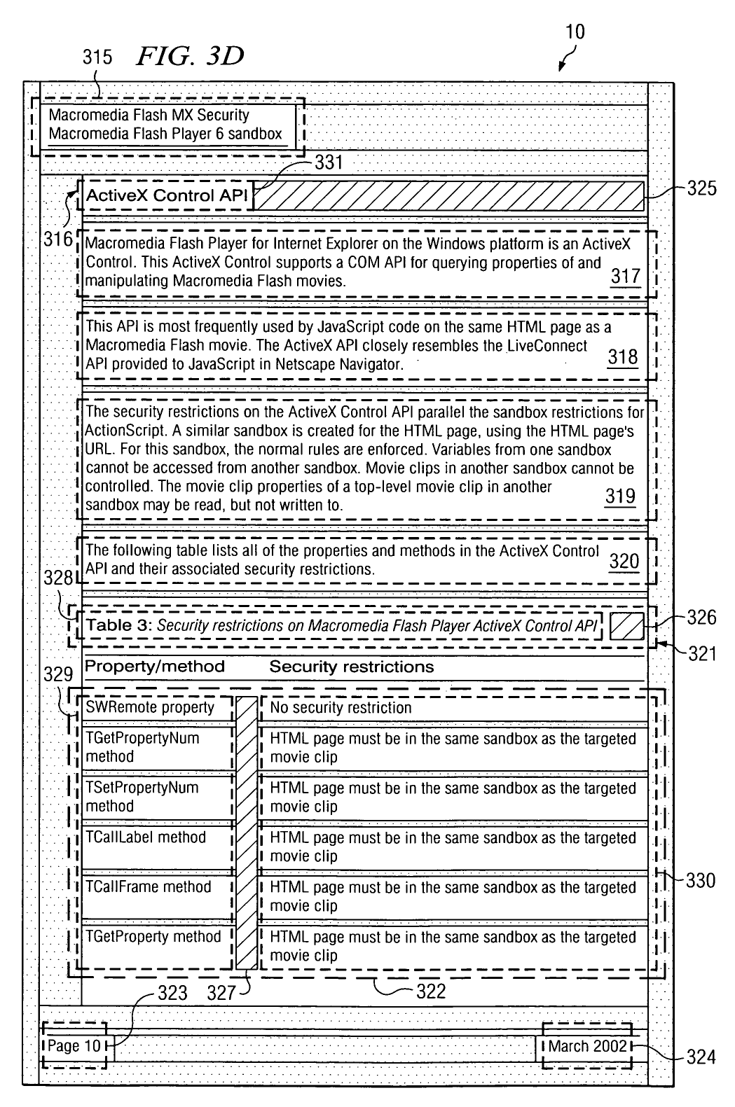

FIG. 3A is an illustration of electronic document 10, as rendered in memory by a conversion application configured according to another embodiment of the present invention. Electronic document 10 includes left edge 300 and right edge 301 that define the horizontal boundaries of electronic document 10. As the conversion application is initiated, horizontal lines 302-304 are established across electronic document 10. In the first pass of the conversion process, horizontal lines that can completely span electronic document 10 from left edge 300 to right edge 301 without intersecting any text, graphic, or glyph are established. The conversion application calculates the coverage or physically paints horizontal lines 302-304 according the amount of whitespace available. For example, horizontal lines 302 are wide because there is more whitespace within electronic document 10 around the header and footer information. Furthermore, horizontal lines 303 are established traversing electronic document 10 from left edge 300 to right edge 301 between the lines of normal paragraph text within box 100 (FIG. 1), while horizontal lines 304 are established between the lines of text in the table of box 101 (FIG. 1).

FIG. 3B is an illustration of electronic document 10, as rendered in memory by a conversion application configured according to another embodiment of the present invention, showing vertical lines 307 and 308 established within the first pass of the conversion application. After horizontal lines 302-304 (FIG. 3A) have been established, the conversion application provides or physically paints vertical lines 307 and 308 able to traverse electronic document 10 from top edge 305 to foot edge 306. As with horizontal lines 302-304 (FIG. 3A), the conversion application only establishes vertical lines 307 and 308 within the whitespace that allows vertical lines 307 and 308 to span electronic document 10 between top edge 305 and foot edge 306 without intersecting any text, graphic, or glyph. As with horizontal lines 302-304, the width of the line depends on the amount of whitespace between such text, graphics, or glyphs.

Once vertical lines 307 and 308 have been established in memory, the conversion application begins analyzing the rectangles that are created by the intersections. Based on the patterns of the various intersections, the conversion application will divide electronic document 10 into a number of discrete divisions or rectangles. The major divisions or rectangles identified by the conversion application for electronic document 10 are rectangles 309-311. Rectangle 309 incorporates the header information of electronic document 10. Rectangle 310 incorporates the body text, and rectangle 311 incorporates the footer information of electronic document 10. The conversion application will continue making passes establishing horizontal and vertical lines within each of the defined rectangles, such as rectangles 309-311, until the size of the division or rectangle becomes small enough that the conversion application can determine it is of no further interest.

FIG. 3C is an illustration of electronic document 10, as rendered in memory by a conversion application configured according to another embodiment of the present invention, showing vertical lines 312-314 established during the second pass of the conversion application. During the second pass, the conversion application first attempts to establish horizontal lines within each of rectangles 309-311 that span the entirety of rectangles 309-311 without intersecting any text, graphics, or glyphs. In the illustrated example, no horizontal lines are established because the illustrated text prevents any horizontal lines from completely traversing rectangles 309-311. The conversion application then attempts to establish vertical lines. Vertical line 312 is established from the top to the bottom of rectangle 309, creating new rectangle 315. Vertical line 313 is established from the top to the bottom of rectangle 310 creating new rectangles 317-322. Vertical line 314 is established from the top to the bottom of rectangle 311 creating new rectangles 323 and 324.

As the conversion application analyzes the intersections created in rectangle 310 by vertical line 313, it recognizes the consistent widths of the horizontal lines separating rectangles 317-321 and determines that each of those should be separate rectangles instead of a single rectangle having multiple horizontal divisions. Similarly, the conversion application recognizes both the consistent widths and the pattern of the horizontal lines spanning rectangle 322 and creates rectangle 322 instead of multiple rectangles.

It should be noted that the conversion application creates a data structure of each rectangle created in the line establishment process associating each rectangle with that rectangles parent rectangle, i.e., each rectangle that is contained within a rectangle.

FIG. 3D is an illustration of electronic document 10, as rendered in memory by a conversion application configured according to another embodiment of the present invention, showing vertical lines 325-327 established within the third pass of the conversion application. Similar to the second pass, no horizontal lines have been established because the text of the document prevents lines from horizontally traversing any of rectangles 315-324. Vertical line 325 is established across rectangle 316 creating new rectangle 331. Vertical line 326 is established across rectangle 321 creating new rectangle 328, and vertical line 327 is drawn across rectangle 322 creating new rectangles 329 and 330.

The conversion application analyzes the intersections and determines that rectangle 315 defines a heading construct, rectangles 317-320 define normal paragraphs, and rectangles 329 and 330 combine to define a two-column table. Rectangle 328 is determined to be another heading of some sort. The conversion application uses a knowledge base to make the determinations of what type of document constructs are defined by the rectangles or divisions created by the multiple passes of horizontal and vertical lines.

For example, computer program logic within the conversion application may determine that repetitive horizontal lines that are as wide as the typical character height may be defining a normal paragraph construct. However, if those lines are bisected by a vertical line with some kind of width, depending on the arrangements of the divisions or rectangles within the document, the conversion application may determine the rectangles to define a multi-column document or a table or a list. Through running of the computer program logic, the conversion application may determine that the dividing vertical lines create a smaller division or rectangle that contains a bullet glyph or number in front of a larger rectangle, such as rectangle 329. The smaller relation of the division or rectangle containing the bullet or number may indicate that the rectangles combine to define a bulleted or numbered list. Thus, the computer program logic of the conversion application analyzes the relationships between graphics/glyphs and text, as well as text formatting to perform its pattern recognition for determining the various document constructs.

Once the conversion application has finished analyzing each of the divisions or rectangles defined by the horizontal and vertical lines, construct codes are generated and added to the information stream defining electronic document 10. For example, if the conversion application were converting electronic document 10 into an HTML document, the text of rectangles 317-320 would be converted into HTML by spanning the text with HTML paragraph tags. Furthermore, the text of rectangles 329 and 320 would be converted to HTML by incorporating the appropriate HTML table tags generated by the conversion application. It should be noted that the conversion application would have divided rectangles 329 and 320 further to define the cell contents of the represented table construct. Thus, when generating the HTML table tags, the conversion application is capable of placing the correct table tag corresponding to the appropriate table cell.

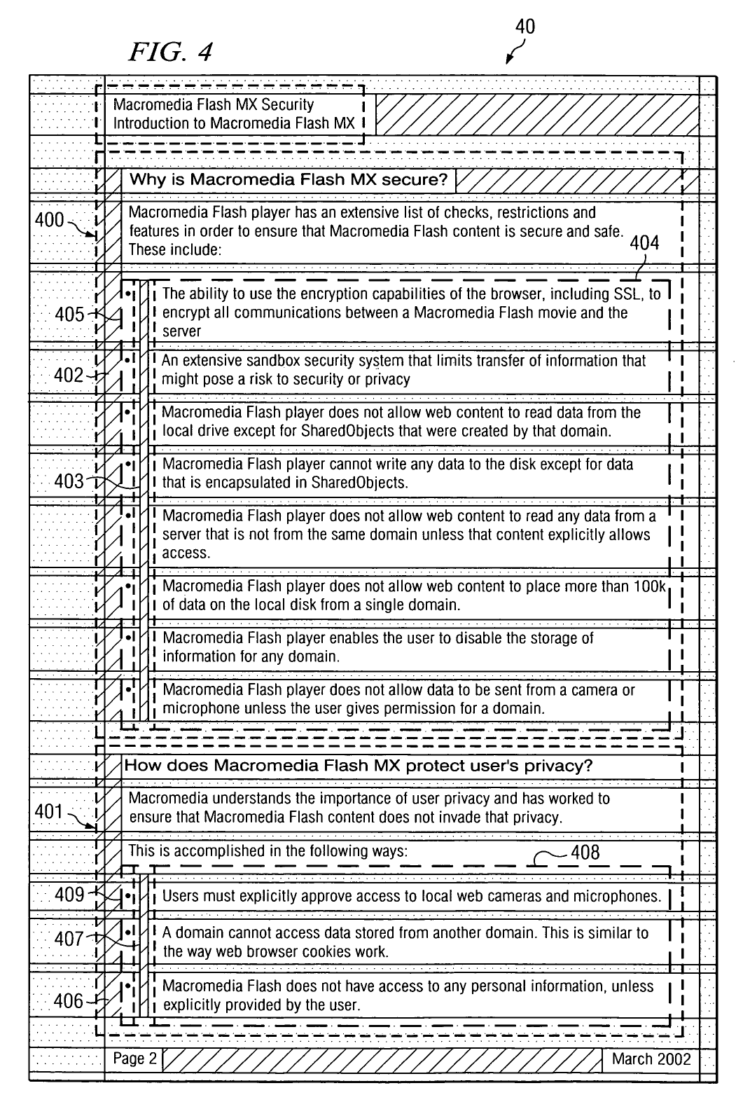

FIG. 4 is an illustration of electronic document 40, as rendered in memory by a conversion application configured according to another embodiment of the present invention. The conversion application has completed its multiple passes establishing horizontal and vertical lines across the available whitespace of electronic document 40. After the first pass of lines, the conversion application identifies divisions 400 and 401 of electronic document 40. The conversion application then establishes vertical line 402 across division 400. In analyzing the areas with the intersections of vertical line 402, the conversion application recognizes the patterns of the title and introduction paragraph and the available whitespace for vertical line 403 and separates division 400 with subdivision 404. Once divided, the conversion application establishes vertical line 403 further dividing subdivision 404 separating the bullets into subdivision 405 and the bulleted text.

The software logic of the conversion application operating on electronic document 40 analyzes subdivisions 404 and 405 and determines that, with the inclusion of vertical line 403 separating divisions 404 and 405, the combination of divisions 404 and 405, in which a series of bullet glyphs vertically align with the blocks of text in division 404, defines a pattern that may be interpreted as a bulleted list. As the conversion application continues to convert electronic document 40 into another type of document, such as a DOC format file, it will generate formatting code to apply to the document information stream which defines the graphically represented text and bullets in divisions 404 and 405 as a DOC file bullet list.

Division 401 is further divided by the application of vertical line 406, which, after the software logic of the conversion application analyzes the available whitespace and intersections with vertical line 406, creates subdivision 408. Conversion application then establishes vertical line 407 which further divides subdivision 408 separating bullet division 409 from the remaining text in subdivision 408. Once again, the software logic of the conversion application determines that the size and relationship of bullet division 409 with its bullet glyphs and subdivision 408, along with the location of vertical line 407 defines another bulleted list. Therefore, as the conversion application continues to convert electronic document 40 into another type of document, such as a DOC format file, it will generate formatting code to apply to the document information stream that defines the graphically represented text and bullets in bullet division 409 and subdivision 408 as a DOC file bullet list.

The conversion application, thus, not only uses the spacing of the rectangles or divisions to determine and interpret the various constructs, but also considers what is actually contained in the adjoining areas. It considers the spacing, alignment, adjoining constructs, glyphs, graphics, text, formatting, and the like to identify patterns that may then be compared against a database of known construct patterns.

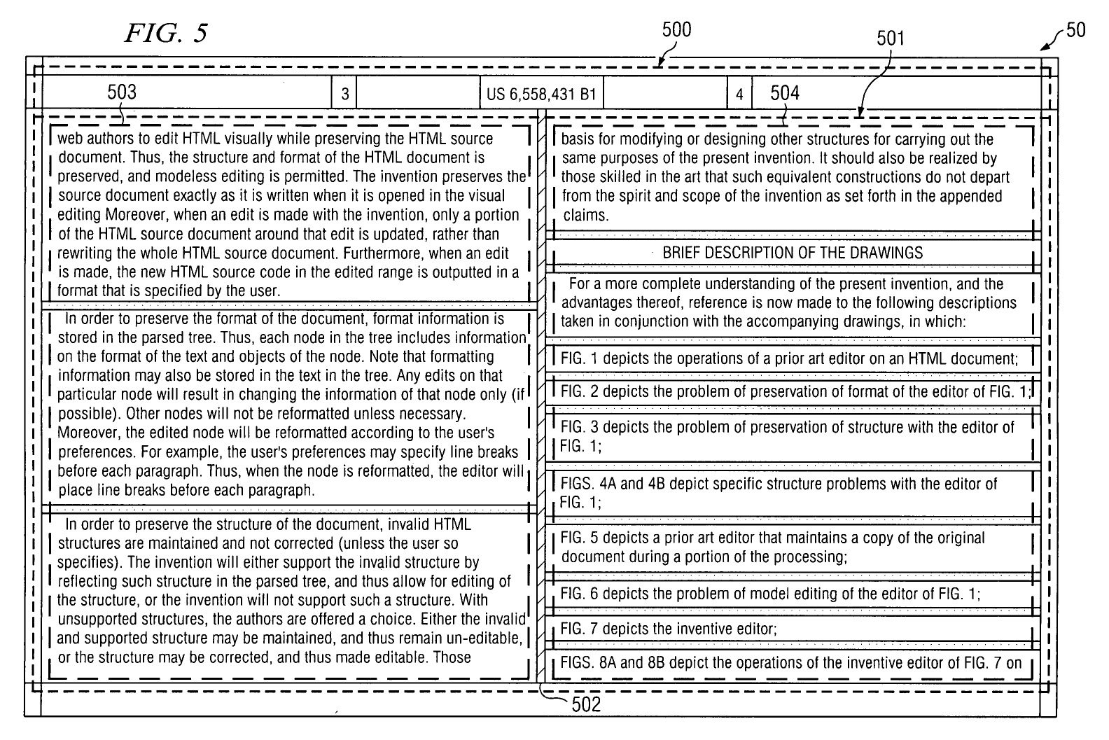

FIG. 5 is an illustration of electronic document 50, as rendered in memory by a conversion application configured according to another embodiment of the present invention. The conversion application has completed its multiple passes establishing horizontal and vertical lines across the available whitespace of electronic document 50. After the first pass of lines, the conversion application identifies two divisions, divisions 500 and 501, of electronic document 50. In a subsequent pass, the conversion application establishes vertical line 502 dividing division 501 into two sections, sections 503 and 504. The conversion application would continue drilling down into each section to determine additional constructs. However, the software logic running within the conversion application analyzes sections 503 and 504 divided by vertical line 502 and determines that sections 503 and 504 define two columns of electronic document 50. Therefore, as the conversion application continues to convert electronic document 50 into another type of document, such as an RTF format file, it will generate formatting code to apply to the document information stream which defines the text of sections 503 as RTF file columns.

It should be noted that the various embodiments of the present invention illustrated in FIGS. 3-5 show the horizontal lines only traversing around the paragraphs. However, in operation, horizontal lines are established across any whitespace that is available that spans either from edge-to-edge of the entire document, for the first pass, or completely spanning each subsequently defined rectangle or division, for the subsequent passes. The conversion application analyzes the widths and relations of these horizontal lines to determine which may be of interest. As the conversion application determines that a line may only define a normal paragraph style, it may ignore those lines defining the normal style. Thus, as the conversion application continues its passes, lines and intersections that are not of interest are ignored, focusing instead on the lines and intersections that may define a special document construct.

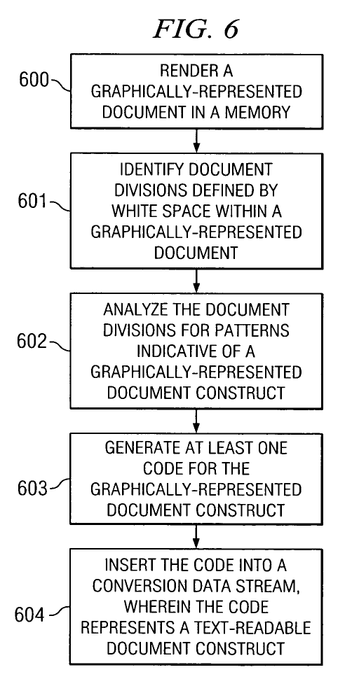

FIG. 6 is a flowchart illustrating example steps taken to implement one embodiment of the present invention. In step 600, a graphical document is rendered in a memory. Whitespace is then virtually or physically painted, in step 601, within the graphical document. In step 602, the document divisions created by the painted whitespace are analyzed for patterns indicative of graphically-represented document construct. At least one code is generated, in step 603, for the graphically-represented document construct. In step 604, the code is inserted into a conversion data stream, wherein it represents the text-readable document construct.

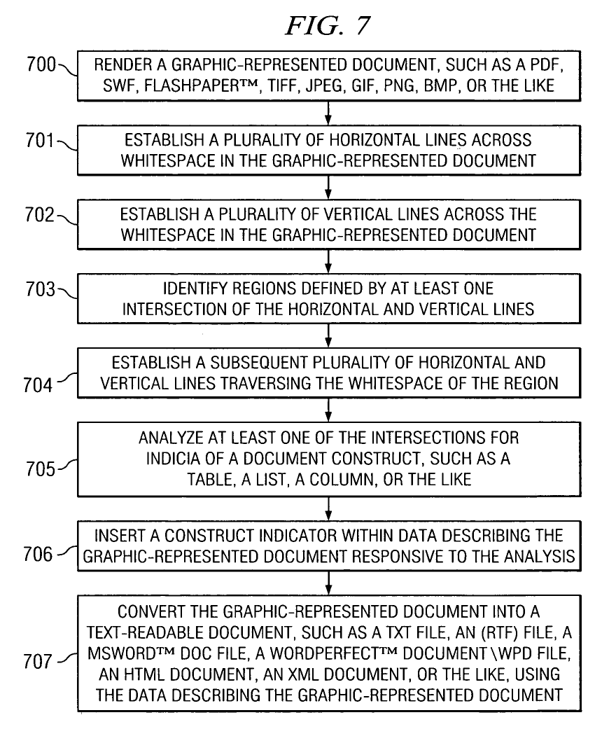

FIG. 7 is a flowchart illustrating example steps performed in implementing another embodiment of the present invention. In step 700, a graphic-represented document, such as a PDF, SWF, FLASHPAPER™, TIFF, JPEG, GIF, PNG, BMP, or the like, is rendered in memory. A plurality of horizontal lines are then established in memory, in step 701, across whitespace in the graphic-represented document. A plurality of vertical lines are also established in memory, in step 702, across the whitespace in the graphic-represented document. In step 703, regions defined by at least one intersection of the horizontal and vertical lines are identified. A subsequent plurality of horizontal and vertical lines are then virtually established, in step 704, traversing the whitespace of the region.

In step 705, at least one of the regions are then analyzed for indicia of a document construct, such as a table, a list, a column, or the like. In step 706, a construct indicator is inserted within data describing the graphic-represented document responsive to the analysis. In step 707, the graphic-represented document is converted into a text-readable document, such as a TXT file, an (RTF) file, a MSWORD™ DOC file, a WORDPERFECT™ document \WPD file, an HTML document, an XML document, or the like, using the data describing he graphic-represented document.

It should be noted that in the examples described above with regard to FIGS. 3-5, the various embodiment, were described as virtually painting, inserting, or establishing the horizontal and vertical lines within the text as rendered in memory. Because the process occurs in memory, some embodiments of the present invention may establish this lines by actually placing the lines onto the rendered version of the document within memory. However, other embodiments may establish these lines by calculating the projected coverage of such lines, such that the lines are not actually painted in memory, but the spaces that they would define are calculated. The same pattern recognition then occurs regardless of whether the particular embodiment establishes the lines by actually painting the lines in memory or by merely calculating the spatial relationships that would result if such lines were, in fact, drawn.

The program or code segments making up the various embodiments of the present invention can be stored in a computer readable medium or transmitted by a computer data signal embodied in a carrier wave, or a signal modulated by a carrier, over a transmission medium. The “computer readable medium” may include any medium that can store or transfer information. Examples of the computer readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (RF) link, and the like. The computer data signal may include any signal that can propagate over a transmission medium such as electronic network channels, optical fibers, air, electromagnetic, RF links, and the like. The code segments may be downloaded via computer networks such as the Internet, Intranet, and the like.

FIG. 8 illustrates computer system 800 adapted to use embodiments of the present invention, e.g. storing and/or executing software associated with the embodiments. Central processing unit (CPU) 801 is coupled to system bus 802. The CPU 801 may be any general purpose CPU. However, embodiments of the present invention are not restricted by the architecture of CPU 801 as long as CPU 801 supports the inventive operations as described herein. Bus 802 is coupled to random access memory (RAM) 803, which may be SRAM, DRAM, or SDRAM. ROM 804 is also coupled to bus 802, which may be PROM, EPROM, or EEPROM. RAM 803 and ROM 804 hold user and system data and programs as is well known in the art.

Bus 802 is also coupled to input/output (I/O) controller card 805, communications adapter card 811, user interface card 808, and display card 809. The I/O adapter card 805 connects storage devices 806, such as one or more of a hard drive, a CD drive, a floppy disk drive, a tape drive, to computer system 800. The I/O adapter 805 is also connected to a printer (not shown), which would allow the system to print paper copies of information such as documents, photographs, articles, etcetera. Note that the printer may be a printer (e.g. dot matrix, laser, etcetera.), a fax machine, scanner, or a copier machine. Communications card 811 is adapted to couple the computer system 800 to a network 812, which may be one or more of a telephone network, a local (LAN) and/or a wide-area (WAN) network, an Ethernet network, and/or the Internet network. User interface card 808 couples user input devices, such as keyboard 813, pointing device 807, etcetera to the computer system 800. The display card 809 is driven by CPU 801 to control the display on display device 810.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method for defining a document construct in a graphic-represented document comprising:
rendering, by at least one processor, said graphic-represented document in memory;
establishing, by one of said at least one processors, a plurality of horizontal and vertical lines in said memory across whitespace in said graphic-represented document;
determining, by one of said at least one processors, at least one region defined by intersections of said plurality of horizontal and vertical lines;
analyzing, by one of said at least one processors, said at least one region defined by said intersections for indicia of any of a plurality of different types of document constructs;
determining at least one document construct associated with said at least one region based on at least one of said indicia, and
responsive to said analyzing, inserting, by one of said at least one processors, within data describing said graphic-represented document a construct indicator associated with said at least one region that indicates at least one document construct identified by said analyzing.

2. The method of claim 1 wherein said establishing comprises:
painting, by one of said at least one processors, virtual lines in memory onto said graphic-represented document.

3. (canceled)

4. The method of claim 1, further comprising:
establishing a subsequent plurality of horizontal and vertical lines traversing said whitespace of said at least one region, wherein said subsequent plurality of horizontal and vertical lines have variable widths;
determining, by one of said at least one processors, at least one sub-region defined by intersections of said subsequent plurality of horizontal and vertical lines;
analyzing, by one of said at least one processors, said at least one sub-region defined by said intersections of said subsequent plurality of horizontal and vertical lines for said indicia; and
inserting, by one of said at least one processors, a construct indicator within data describing said graphic-represented document responsive to said analyzing.

5. The method of claim 1 further comprising:
converting, by one of said at least one processors, said graphic-represented document into a text-readable document using said data describing said graphic-represented document.

6. The method of claim 5 wherein said text-readable document comprises one of:
a text (TXT) file;
a rich text format (RTF) file;
a MSWORD™ document (DOC) file;
a WORDPERFECT™ document (WPD) file;
a hypertext markup language (HTML) document; and
an extensible markup language (XML) document.

7. The method of claim 1 wherein said graphic-represented document comprises one of:
a portable document format (PDF) document;
a small web file (SWF) document;
a FLASHPAPER™ document;
a tagged image file format (TIFF) document;
a joint photographics expert group (JPEG) document;
a graphics interchange format (GIF) document;
a portable network graphic (PNG) document; and
a bit-mapped (BMP) document.

8. The method of claim 1 wherein said plurality of different types of document constructs comprise at least:
a table;
a list;
a column;
a paragraph;
a graphical annotation;
an annotated graphic; and
an article.

9. The method of claim 1 wherein said analyzing comprises:
evaluating, by one of said at least one processors, contents of said graphic-represented document adjoining said at least one region;
considering, by one of said at least one processors, spacing between said at least one region;
examining, by one of said at least one processors, alignment of said at least one region;
identifying, by one of said at least one processors, formatting within said at least one region; and
comparing, by one of said at least one processors, results of said evaluating, said considering, said examining, and said identifying to a plurality of construct patterns.

10. The method of claim 1 further comprising:
storing, by one of said at least one processors, a record of said at least one region in a data structure.

11. A method for converting graphically-represented document constructs into text-readable document constructs comprising:
rendering, by at least one processors, said graphically-represented document in a memory;
identifying, by one of said at least one processors, one or more document divisions defined by whitespace within said graphically-represented document, said identifying including establishing one or more horizontal and vertical lines indicating said divisions and determining, by one of said at least one processors, at least one region defined by intersections of said plurality of horizontal and vertical lines;
analyzing, by one of said at least one processors, said one or more document divisions for patterns indicative of said graphically-represented document construct, wherein said analyzing comprises:
evaluating, by one of said at least one processors, contents of said graphically-represented document adjoining at least one of said one or more document divisions,
considering, by one of said at least one processors, spacing between said at least one of said one or more document divisions,
examining, by one of said at least one processors, alignment of said at least one of said one or more document divisions,
ascertaining, by one of said at least one processors, formatting within said at least one of said one or more document divisions, and
comparing, by one of said at least one processors, results of said evaluating, said considering, said examining, and said ascertaining to a plurality of construct patterns;
determining, by one of said at least one processors, at least one document construct associated with said at least one or more document divisions based on said comparing, and
generating, by one of said at least one processors, at least one code for said graphically-represented document construct; and
inserting, by one of said at least one processors, said at least one code into a conversion data stream, wherein said at least one code represents said text-readable document construct.

12. The method of claim 11 wherein said one or more horizontal and vertical lines does not touch elements of said graphically-represented document.

13. The method of claim 12 wherein said establishing comprises:
painting, by one of said at least one processors, virtual lines in memory onto said graphically-represented document.

14. The method of claim 12 wherein said establishing comprises:
calculating, by one of said at least one processors, a region covered by said horizontal and vertical lines without rendering said horizontal and vertical lines in said memory.

15. The method of claim 12 wherein said identifying further comprises:
establishing, by one of said at least one processors, one or more horizontal and vertical section lines across a width of said one or more document division, wherein said one or more horizontal and vertical section lines does not touch elements within said one or more document division.

16. The method of claim 11 wherein said graphically-represented document comprises one of:
a portable document format (PDF) document;
a small web file (SWF) document;
a FLASHPAPER™ document;
a tagged image file format (TIFF) document;
a joint photographics expert group (JPEG) document;
a graphics interchange format (GIF) document;
a portable network graphic (PNG) document; and
a bit-mapped (BMP) document.

17. The method of claim 11 wherein a text-readable document containing said text-readable document construct comprises one of:
a text (TXT) file;
a rich text format (RTF) file;
a MSWORD™ document (DOC) file;
a WORDPERFECT™ document (WPD) file;
a hypertext markup language (HTML) document; and
an extensible markup language (XML) document.

18. The method of claim 11 wherein said text-readable document construct comprises one or more of:
a table;
a list;
a column;
a paragraph;
a graphical annotation;
an annotated graphic; and
an article.

19. (canceled)

20. The method of claim 11 further comprising:
storing, by one of said at least one processors, data relating to said one or more document divisions into a data structure.

21. A computer program product having a non-transitory computer readable medium with computer program logic recorded thereon for defining a document construct in a graphic-represented document, said computer program product comprising:
code for rendering said graphic-represented document in memory;
code for establishing a plurality of horizontal and vertical lines in said memory across whitespace in said graphic-represented document;
code for determining, by one of said at least one processors, at least one region defined by intersections of said plurality of horizontal and vertical lines;
code for analyzing at least one region defined by one or more intersections of said plurality of horizontal lines and said plurality of vertical lines for indicia of said document construct;
code for determining at least one document construct associated with said at least one region based on at least one of said indicia,
code for establishing a subsequent plurality of horizontal and vertical lines traversing said whitespace of said at least one region;
code for analyzing at least one sub-region defined by one or more intersections of said subsequent plurality of horizontal and vertical lines for said indicia; and
code for determining at least one document construct associated with said at least one sub-region based on at least one of said indicia, and
code for inserting a construct indicator within data describing said graphic-represented document responsive to said analyzing of said at least one region and said at least on sub-region.

22. The computer program product of claim 21 wherein said code for establishing comprises:
code for painting virtual lines in memory onto said graphic-represented document.

23. The computer program product of claim 21 wherein said code for establishing comprises:
code for calculating a region covered by said horizontal and vertical lines.

24. (canceled)

25. The computer program product of claim 21 further comprising:
code for converting said graphic-represented document into a text-readable document using said data describing said graphic-represented document.

26. The computer program product of claim 25 wherein said text-readable document comprises one of:
a text (TXT) file;
a rich text format (RTF) file;
a MSWORD™ document (DOC) file;
a WORDPERFECT™ document (WPD) file;
a hypertext markup language (HTML) document; and
an extensible markup language (XML) document.

27. The computer program product of claim 21 wherein said graphic-represented document comprises one of:
a portable document format (PDF) document;
a small web file (SWF) document;
a FLASHPAPER™ document;
a tagged image file format (TIFF) document;
a joint photographics expert group (JPEG) document;
a graphics interchange format (GIF) document;
a portable network graphic (PNG) document; and
a bit-mapped (BMP) document.

28. The computer program product of claim 21 wherein said document construct comprises one or more of:
a table;
a list;
a column;
a paragraph;
a graphical annotation;
an annotated graphic; and
an article.

29. A computer program product having a non-transitory computer readable medium with computer program logic recorded thereon for defining a document construct in a graphic-represented document, said computer program product comprising:
code for rendering said graphic-represented document in memory;
code for establishing a plurality of horizontal and vertical lines in said memory across whitespace in said graphic-represented document;
code for determining, by one of said at least one processors, at least one region defined by intersections of said plurality of horizontal and vertical lines;
code for analyzing at least one region defined by one or more intersections of said plurality of horizontal lines and said plurality of vertical lines for indicia of said document construct;
code for determining at least one document construct associated with said at least one region based on at least one of said indicia;
code for inserting a construct indicator within data describing said graphic-represented document responsive to said analyzing;
wherein said code for analyzing comprises:
code for evaluating contents of said graphic-represented document adjoining said at least one region;
code for considering spacing between said at least one region;
code for examining alignment of said at least one region;
code for identifying formatting within said at least one region;
code for comparing results of execution of said code for evaluating, said code for considering, said code for examining, and said code for identifying to a plurality of construct patterns.

30. The computer program product of claim 21 further comprising:
code for saving information associated with at least one region in a data structure.

31. A system for converting graphically-represented document constructs into text-readable document constructs comprising:
a processor; and
a memory,
wherein the memory embodies at least one program component comprising:
code that configures the processor to render said graphically-represented document in the memory;
code that configures the processor to identify at least one document division defined by whitespace within said graphically-represented document, wherein said identifying includes creating lines in said white space and wherein intersections of said lines define said division and determining at least one document division defined by intersections of said plurality of horizontal and vertical lines;
code that configures the processor to analyze said at least one document division for patterns indicative of said graphically-represented document construct;
code that configures the processor to determine at least one document construct associated with said at least one division, and
code that configures the processor to generate at least one code for said graphically-represented document construct; and
code that configures the processor to insert said at least one code into a conversion data stream, wherein said at least one code represents said text-readable document construct;
wherein said code that configures the processor to analyze configures the processor to:
evaluate contents of said graphically-represented document adjoining said at least one region;
consider spacing between said at least one region;
examine alignment of said at least one region;
ascertain formatting within said at least one region; and
compare results of evaluating, considering, and ascertaining to a plurality of construct patterns.

32. The system of claim 31 wherein said code that configures the processor to identify configures the processor to:
establish one or more horizontal and vertical lines across a width of said graphically-represented document, wherein said one or more horizontal and vertical lines does not touch elements of said graphical document.

33. The system of claim 32 wherein establishing comprises painting virtual lines in memory onto said graphically-represented document.

34. The system of claim 32 wherein establishing comprises:
calculating a region covered by said horizontal and vertical lines, wherein said horizontal and vertical lines are not rendered in said memory onto said graphically-represented document.

35. A system for converting graphically-represented document constructs into text-readable document constructs comprising:
a processor; and
a memory,
wherein the memory embodies at least one program component comprising:
program code that configures the processor to render said graphically-represented document in the memory;
program code that configures the processor to identify at least one document division defined by whitespace within said graphically-represented document, wherein said identifying includes creating lines in said white space so that intersections of said lines define said divisions, wherein identifying further comprises establishing one or more horizontal and vertical section lines across a width of said at least one document division, wherein said one or more horizontal and vertical section lines does not touch elements within said at least one document division;
program code that configures the processor to analyze said at least one document division for patterns indicative of said graphically-represented document construct;
program code that configures the processor to determine at least one document construct associated with said at least one region based on at least one of said indicia, and
program code that configures the processor to generate at least one code for said graphically-represented document construct; and
program code that configures the processor to insert said at least one code into a conversion data stream, wherein said at least one code represents said text-readable document construct.

36. The system of claim 31 wherein said graphical document comprises one of:
a portable document format (PDF) document;
a small web file (SWF) document;
a FLASHPAPER™ document;
a tagged image file format (TIFF) document;
a joint photographics expert group (JPEG) document;
a graphics interchange format (GIF) document;
a portable network graphic (PNG) document; and
a bit-mapped (BMP) document.

37. The system of claim 31 wherein a text-readable document containing said text-readable document construct comprises one of:
text (TXT) file;
a rich text format (RTF) file;
a MSWORD™ document (DOC) file;
a WORDPERFECT™ document (WPD) file;
a hypertext markup language (HTML) document; and
an extensible markup language (XML) document.

38. The system of claim 31 wherein said text-readable document construct comprises one or more of:
a table;
a list;
a column;
a paragraph;
a graphical annotation;
an annotated graphic; and
an article.

39. (canceled)

40. The system of claim 31, wherein the memory further comprises:
code for storing data related to said at least one document divisions into a data structure.

41. The method of claim 1, wherein said horizontal and vertical lines have variable widths.

42. The method of claim 1, wherein said horizontal lines span the entire width of a page of the graphically-represented document, and said vertical lines span the entire length of the page of the graphically-represented document.

43. The method of claim 42, further comprising:
establishing at least one subsequent horizontal line and at least one subsequent vertical line traversing said whitespace of said at least one region, wherein said subsequent horizontal line spans the entire width of said at least one region and said subsequent vertical line spans the entire length of said at least one region;
determining, by one of said at least one processors, at least one sub-region defined by intersections of said subsequent horizontal and vertical lines;
analyzing, by one of said at least one processors, said at least one sub-region defined by said intersections of said subsequent horizontal and vertical lines for said indicia; and
inserting, by one of said at least one processors, a second construct indicator associated with said sub-region within data describing said graphic-represented document responsive to said analyzing.

44. The method of claim 43, wherein said horizontal and vertical lines have variable widths.

45. A non-transitory computer-readable medium comprising program code for causing a processor to execute a method, the program code comprising:
program code for rendering a graphic-represented document in memory;
program code for establishing a plurality of horizontal and vertical lines in said memory across whitespace in said graphic-represented document;
program code for analyzing at least one region defined by said intersections for indicia of any of a plurality of different types of document constructs;
program code for, responsive to said analyzing, inserting within data describing said graphic-represented document a construct indicator associated with said at least one region, the construct indicator configured to indicate at least one document construct identified by said analyzing.
